(19) United States
(12) Patent Application Publication
(10) Pub. No.: US 2003/0131713 A1
(43) Pub. Date: Jul. 17, 2003

(54) Electronic musical apparatus for blocking duplication of copyrighted music piece data

(75) Inventors: Kazuo Haruyama, Hamamatsu-shi (JP); Hiroyuki Sugiura, Hamamatsu-shi (JP)

Correspondence Address: David L. Fehrman, Morrison & Foerster LLP, 555 W. 5th Street, 35th Floor, Los Angeles, CA, 90013, US

(73) Assignee: Yamaha Corporation, Hamamatsu-shi (JP)

(21) Appl. No.: 10/339,120

(22) Filed: Jan. 9, 2003

(30) Foreign Application Priority Data
Jan. 11, 2002 (JP) 2002-004349

(51) Int. Cl. G10H 7/00

(52) U.S. Cl. 84/602

(57) ABSTRACT

An electronic musical instrument A automatically performs a music piece by replaying music piece data. When music piece data stored in an external storage device 36 or music piece data taken in via an interface circuit 51 is stored in an internal storage device 35, filenames of copyrighted music piece data among the above-described music piece data are automatically changed. When music piece data stored in a ROM 33 or the internal storage device 35 is copied into the external storage device 36 or is outputted to the outside via the interface circuit 51, the copy and the output of copyrighted music piece data among the above-described music piece data is prohibited. When an external device 52 requests the electronic musical instrument A to transmit music piece data stored in the internal storage device 35 or the like, filenames of copyrighted music piece data among the above-described music piece data are protected from being displayed on the external device 52. As described above, copyright on music piece data is protected easily and effectively.

### BACKGROUND OF THE INVENTION

1. Field of the Invention

The present invention relates to an electronic musical apparatus which is configured to block duplication of copyrighted music piece data and transmission of copyrighted music piece data to external devices, to a method applied to the electronic musical apparatus, and to a computer program applied to the external devices.

2. Description of the Related Art

Conventionally, when copyrighted music piece data representing a music piece is sold, being stored in flexible disc, compact disc or the like, copyright data is also recorded in order to protect the copyrighted music piece data against unauthorized duplication. The copyright data, which can be provided for plural sets of music piece data in common or for each set of music piece data, includes name of composer, date of composition, name of producer, and date of production. When the copyrighted music piece data is taken in from an external device including communications circuit, the music piece data is stored with the aforementioned copyright data added.

However, the above-described measure of adding copyright data to music piece data is not enough to prevent unauthorized duplication. In particular, once copyrighted music piece data is taken in to an electronic musical apparatus such as electronic musical instrument or personal computer from an external recording medium, external device, etc., it is impossible to block unauthorized duplication for editing, etc. Another problem is that adding copyright data to taken-in music piece data is a cumbersome task.

### SUMMARY OF THE INVENTION

The present invention was accomplished to solve the above-described problems, and an object thereof is to provide an electronic musical apparatus, a program, or the like which can easily add an identifier by which music piece data can be determined whether it is copyrighted, and can protect more favorably from unauthorized duplication of music piece data.

In order to achieve the above-described object, a feature of the present invention lies in an electronic musical apparatus having a storage device capable of storing, on a file-by-file basis, music piece data representative of a music piece along with its filename, a replay portion for reading the music piece data and replaying the music piece, and a take-in portion for taking in desired music piece data from an external storage medium or an external device and storing the music piece data along with its filename in the storage device, the electronic musical apparatus comprising a determination portion for determining whether the music piece data taken in by the take-in portion is copyrighted, and a filename modification portion for changing the filename of the music piece data taken in by the take-in portion to a predetermined style when the music piece data is determined by the determination portion to be copyrighted and storing the filename in the storage device.

According to the feature, when the music piece data taken in by the take-in portion is copyrighted, the filename of the music piece data is automatically changed to a predetermined style by the functions of the determination portion and the filename modification portion. These functions make it possible to easily distinguish copyrighted music piece data from non-copyrighted data, eliminating the need for processes to add an identifier for the distinction. Moreover, since the determination whether music piece data is copyrighted can be made only by referring to its filename, copyright on music piece data can be favorably protected by disabling the display of filenames of copyrighted music piece data for duplication of music piece data, blocking duplication of such music piece data or protecting the music piece data from being outputted to an external device.

Another feature of the present invention lies in an electronic musical apparatus having a storage device for storing music piece data representative of a music piece, a replay portion for reading the music piece data stored in the storage device and replaying the music piece, and a writing portion capable of writing the music piece data stored in the storage device into an external storage medium, the electronic musical apparatus comprising a determination portion for determining whether the music piece data stored in the storage device is copyrighted, and a write protection portion for protecting the music piece data determined by the determination portion to be copyrighted from being written by the writing portion into the external storage medium.

According to the feature, copyrighted music piece data stored in the storage device is protected from being written into the external storage medium by the functions of the determination portion and the write protection portion. Therefore, unauthorized duplication of copyrighted music piece data is prevented, and copyright on music piece data is favorably secured.

Still another feature of the present invention lies in an electronic musical apparatus having a storage device for storing music piece data representative of a music piece, a replay portion for reading the music piece data stored in the storage device and replaying the music piece, and an output portion capable of outputting the music piece data stored in the storage device to an external device, the electronic musical apparatus comprising a determination portion for determining whether the music piece data stored in the storage device is copyrighted, and an output protection portion for protecting the music piece data determined by the determination portion to be copyrighted from being outputted by the output portion to the external device.

According to the feature, copyrighted music piece data stored in the storage device is protected from being outputted to the external device by the functions of the determination portion and the output protection portion. Therefore, unauthorized duplication of copyrighted music piece data is prevented, and copyright on music piece data is favorably secured.

A further feature of the present invention lies in an electronic musical apparatus having a storage device capable of storing, on a file-by-file basis, music piece data representative of a music piece along with its filename, a replay portion for reading the music piece data stored in the storage device and replaying the music piece, and an output portion capable of outputting the filename stored in the storage device to an external device in response to a request from the external device, and outputting to the external device music piece data corresponding to a filename specified by the external device, the electronic musical apparatus comprising a determination portion for determining whether music piece data stored in the storage device is copyrighted, and an output protection portion for protecting the filename of music piece data determined by the determination portion to be copyrighted from being outputted by the output portion to the external device.

According to the feature, filenames of copyrighted music piece data stored in the storage device are protected from being outputted to the external device by the functions of the determination portion and the output protection portion. Therefore, the external device is unable to display the filenames of copyrighted music piece data, disabling users from selecting copyrighted music piece data. As a result, copyrighted music piece data is virtually protected from being outputted to the external device, so that the copyright on music piece data is favorably secured.

A still further feature of the present invention lies in a method and a computer program applied to an external device which requests an electronic musical apparatus storing music piece data representative of a music piece to transmit the music piece data, the method and the computer program comprising the steps of a determination step for determining whether music piece data stored in the electronic musical apparatus is copyrighted and a prohibition step for prohibiting the external device from requesting the electronic musical apparatus to transmit music piece data determined at the determination step to be copyrighted.

According to the feature, by the determination step and the prohibition step, the external device is prohibited from requesting the electronic musical apparatus to transmit copyrighted music piece data stored in the electronic musical apparatus to the external device. As a result, copyrighted music piece data is not be outputted from the electronic musical apparatus to the external device, so that the copyright on music piece data is favorably secured.

Another feature of the present invention lies in a method and a computer program applied to an external device which requests an electronic musical apparatus storing, on a file-by-file basis, music piece data representative of a music piece along with its filename to transmit the music piece data, the method and the computer program comprising the steps of a filename transmission request step for requesting transmission of filenames stored in the electronic musical apparatus, a display step for displaying, on a display unit, filenames transmitted from the electronic musical apparatus in response to the request for filename transmission, a determination step for determining whether a filename selected by a user from among the filenames displayed on the display unit is of copyrighted music piece data, and a music piece data transmission request step for requesting the electronic musical apparatus to transmit music piece data corresponding to a filename determined at the determination step not to be copyrighted.

According to the feature, by the determination step and the music piece data transmission request step, the external device is prohibited from requesting the electronic musical apparatus to transmit copyrighted music piece data stored in the electronic musical apparatus to the external device, even if a user selects the filename of the copyrighted music piece data on the display unit. As a result, copyrighted music piece data is not be outputted from the electronic musical apparatus to the external device, so that the copyright on music piece data is favorably secured.

Another feature of the present invention lies in a method and a computer program applied to an external device which requests an electronic musical apparatus storing, on a file-by-file basis, music piece data representative of a music piece along with its filename to transmit the music piece data, the method and the computer program comprising the steps of a filename transmission request step for requesting transmission of filenames stored in the electronic musical apparatus, a determination step for determining whether the filenames transmitted from the electronic musical apparatus in response to the request of filename transmission are of copyrighted music piece data, a display step for displaying, on a display unit, filenames determined at the determination step not to be copyrighted among those filenames transmitted from the electronic musical apparatus, and a music piece data transmission request step for requesting the electronic musical apparatus to transmit music piece data corresponding to a filename selected by a user from among the filenames displayed on the display unit at the display step.

According to the feature, by the determination step and the display step, the external device is unable to display the filenames of copyrighted music piece data stored in the electronic musical apparatus. Therefore, users are unable to select filenames of copyrighted music piece data. As a result, copyrighted music piece data can not be substantially outputted to the external device, so that the copyright on music piece data is favorably secured.

In the present invention, the electronic musical apparatus and the external device are configured by an electronic musical instrument, a personal computer, or the like. The storage device may be configured by ROM, flash memory EEPROM, hard disk HD, or the like. The external storage medium may be configured by magnetic or optical storage medium such as flexible disk or compact disk. The music piece data, which is stored or transferred on a file-by-file basis, can be determined to be copyrighted by a specific character string or symbol string added to the filename of the music piece data, the extension of the filename changed to a predetermined style, or the like.

The present invention for the electronic musical apparatus, the method and the computer program can be applied to a system including an electronic musical apparatus and an external device, and to an external device alone. The present invention can also be applied to computer-readable storage media storing programs applied to the electronic musical apparatus, the external device and the system.

### BRIEF DESCRIPTION OF THE DRAWINGS

FIG. 1 is a schematic block diagram showing an electronic musical instrument and its peripheral devices according to an embodiment of the electronic musical apparatus in the present invention;

FIG. 2 is an illustration showing an example format of data storage area of a ROM, an internal storage device, and an external storage device shown in FIG. 1;

FIG. 3 is a format diagram of music piece data stored in the external storage device shown in FIG. 1;

FIG. 4 is a format diagram of music piece data stored in a RAM shown in FIG. 1;

FIG. 5 is a flow chart showing a main program run on the electronic musical instrument shown in FIG. 1;

FIG. 6 is a flow chart showing a music piece data input routine performed at a music piece data input/output process shown in FIG. 5;

FIG. 7 is a flowchart showing a music piece data duplication routine performed at the music piece data input/output process shown in FIG. 5;

FIG. 8 is a flowchart showing a music piece data transmission routine performed at the music piece data input/output process shown in FIG. 5, and a music piece data request program run on the external device shown in FIG. 1;

FIG. 9 is a flowchart showing a music piece data transmission routine and a music piece data request program according to a first modified embodiment;

FIG. 10 is a flow chart showing a music piece data transmission routine and a music piece data request program according to a second modified embodiment; and

FIG. 11 is a flow chart showing a music piece data transmission routine and a music piece data request program according to a third modified embodiment.

### DESCRIPTION OF THE PREFERRED EMBODIMENT

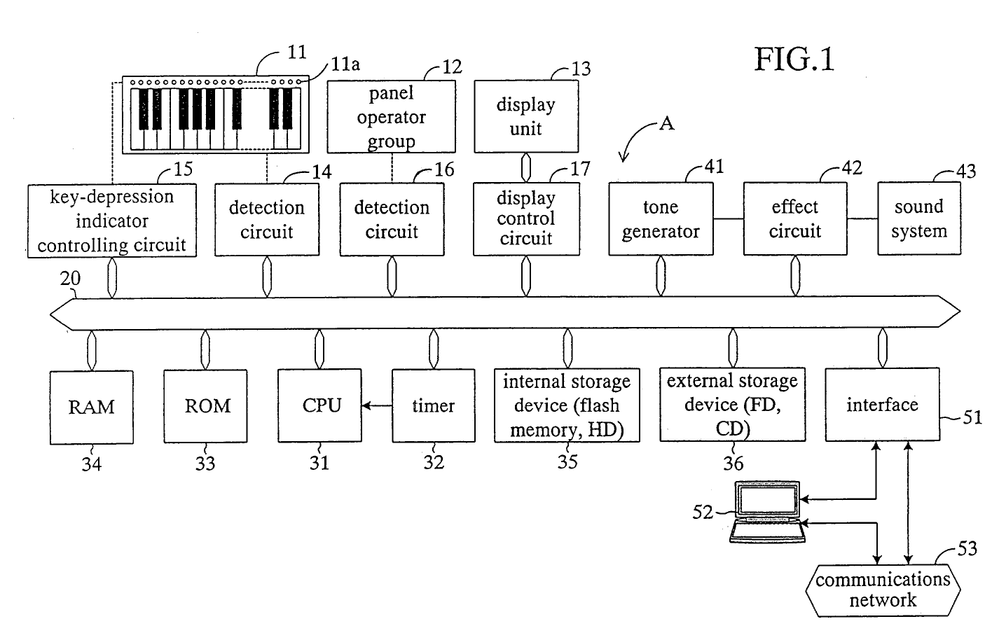

An embodiment of the present invention will now be described with reference to the drawings. FIG. 1 is a block diagram showing an electronic musical instrument A used as an electronic musical apparatus of the present invention, and peripheral devices of the electronic musical instrument A.

The electronic musical instrument A includes a keyboard 11, a panel operator group 12, and a display unit 13. The keyboard 11 has plural keys used as performance operators. The depression and release of the keys cause generation and halt of tone signal. The depression and release of the keys are detected by ON/OFF operation of key switches respectively. The key switches provided in corresponding relation to each key are disposed in a detection circuit 14 which is connected to a bus 20. On the keyboard 11 there are mounted a plurality of a key-depression indicator 11a provided in corresponding relation to each key. The lighting operation of the key-depression indicator 11a is controlled by a key-depression indicator controlling circuit 15.

The panel operator group 12, which is disposed on the front panel of the electronic musical instrument A, is operated in order to trigger various operations on the electronic musical instrument A. In the present embodiment, particularly, the panel operator group 12 is operated in order to trigger such operations as selection, replay, take-in, transfer, or copy of music piece data. The operations of the panel operator group 12 are detected by ON/OFF operations of operator switches. The operator switches provided in corresponding relation to each operator are disposed in a detection circuit 16 which is connected to the bus 20. A display unit 13, which is configured by a liquid crystal display or a cathode ray tube device, etc., displays characters, numerals, graphics, and so on. The mode of display of the display unit 13 is controlled by a display control circuit 17 which is connected to the bus 20.

Connected to the bus 20 are a CPU 31, a timer 32, a ROM 33, a RAM 34, an internal storage device 35, an external storage device 36, a tone generator 41, and an effect circuit 42. The CPU 31, the timer 32, the ROM 33, and the RAM 34, which configure the main unit of a microcomputer, control various operations of the electronic musical instrument A by executing programs.

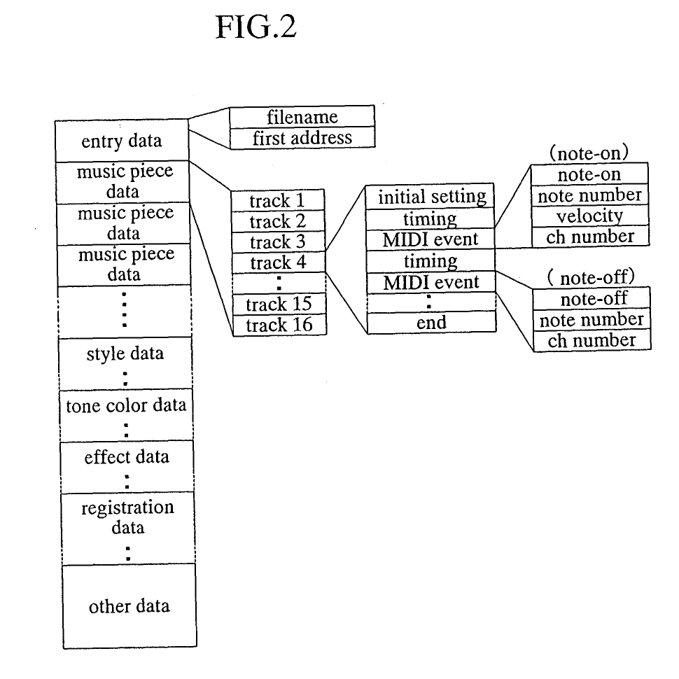

In the ROM 33 there are disposed a program storage area and a data storage area. In the program storage area there are stored a system program, some of programs for implementing various functions of the electronic musical instrument A, and so on. In the data storage area, as shown in FIG. 2, there are stored entry data and plural sets of music piece data representing music pieces, the data being used for automatically performed demonstration. The entry data comprises plural sets of data, each set of which consists of filename data representing a file containing music piece data, and first address data representing the first address of the file. The filename data consists of a filename (e.g., “bluesky”) and an extension representing the file as MIDI data (i.e., “.mid”). When music piece data (music piece file) is copyrighted, the filename of the music piece data is changed to a predetermined style. For example, if not copyrighted, the filename would be “bluesky.mid”, whereas the filename of copyrighted music piece data would be changed to “blueskyxyz.mid”.

As shown in FIG. 2 as an example, each set of music piece data comprises plural tracks (e.g., 16 tracks) of automatic performance data. Each track of automatic performance data contains initial setting data, timing data, MIDI event data, and end data. The initial setting data contains plural kinds of control data for controlling various features of tone signals to be generated such as tone color, effect, style (type of automatic accompaniment pattern), or performance tempo. The timing data represents the time interval between two sets of MIDI event data to be generated. The MIDI event data represents performance events of a musical instrument in accordance with progression of a music piece, specifying note-on, note-off, tone color, effect, and so on.

The performance event data regarding note-on contains such data as note-on data representing the start of generation of a musical tone (key depression), note number data representing the pitch of a generated musical tone (frequency), velocity data representing loudness (velocity of key depression), or channel number data representing a tone signal forming channel. The channel number data corresponds to a tone signal forming channel of the tone generator 41 described in detail later on. The performance event data regarding note-off contains note-off data representing the end of generation of a musical tone (key release), note number data representing the pitch of a generated musical tone (frequency), and channel number data representing a tone signal forming channel. Although the format of the music piece data described above complies with the SMF format, various formats may also be applied without limiting to the SMF.

In the data storage area in the ROM 33 there are stored plural sets of style data, tone color data, effect data, and registration data, along with other data. The style data is for controlling generation of various automatic accompaniment sounds such as march or waltz. The tone color data is for controlling tone colors of the generated musical tones such as piano or guitar. The effect data is for controlling effect to be added to the generated musical tones such as reverberation or chorus. The registration data is for concurrently specifying each set of style data, tone color data, effect data, etc.

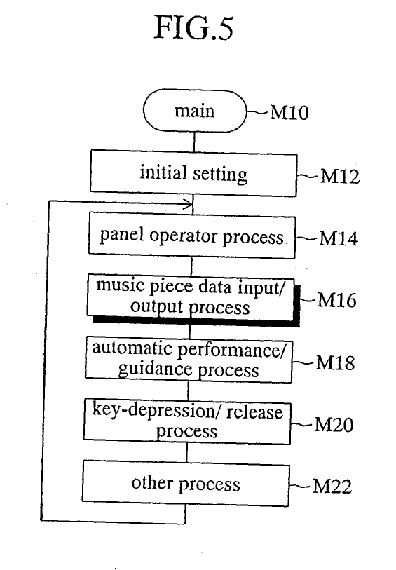

In the present specification, the internal storage device 35, which includes writable nonvolatile memory previously embedded in the electronic musical instrument A such as flash memory EEPROM or hard disk HD and drive units for the nonvolatile memory, is capable of storing and reading voluminous data and programs. In the memory, various kinds of programs (including programs shown in FIGS. 5 to 8 described later), entry data, music piece data, style data, tone color data, effect data, registration data, and other data shown in FIG. 2 are previously stored or externally taken in and stored. These programs and data are the same kinds as those stored in the ROM 33, but different from them.

In the present specification, the external storage device 36, which includes various external storage media applicable to the electronic musical instrument A such as flexible disk FD or compact disk CD and drive units for the external storage media, is capable of storing and reading voluminous data and programs. From and to the external storage media, various kinds of programs and entry data, music piece data, style data, tone color data, effect data, registration data, and other data shown in FIG. 2 are read and written. These programs and data are the same kinds as those stored in the ROM 33, but different from them.

The tone generator 41 has plural tone signal forming channels. Each tone signal forming channel forms tone signals in accordance with performance information (note-on data, note-off data, note number data, velocity data, channel number data, etc.) supplied on the basis of control by the CPU 31. The details on the tone signals formed by each tone signal forming channel such as tone color or accompaniment sound signal are controlled by various control data stored in the ROM 33, the RAM 34, the internal storage device 35 and the external storage device 36, and various control data inputted via an interface circuit 51 described later. These controls over the tone signals are exercised on the basis of the CPU 31.

The effect circuit 42 is for adding various musical effects such as reverberation or chorus to the tone signals generated by the tone generator 41. The effects added by the effect circuit 42 are also controlled by various effect data stored in the ROM 33, the RAM 34, the internal storage device 35 and the external storage device 36, and various effect data inputted via the interface circuit 51 described later, on the basis of the CPU 31. The tone signals to which effects are added by the effect circuit 42 are supplied to a sound system 43. The sound system 43, which includes amplifiers, speakers, etc., generates musical tones corresponding to the supplied tone signals.

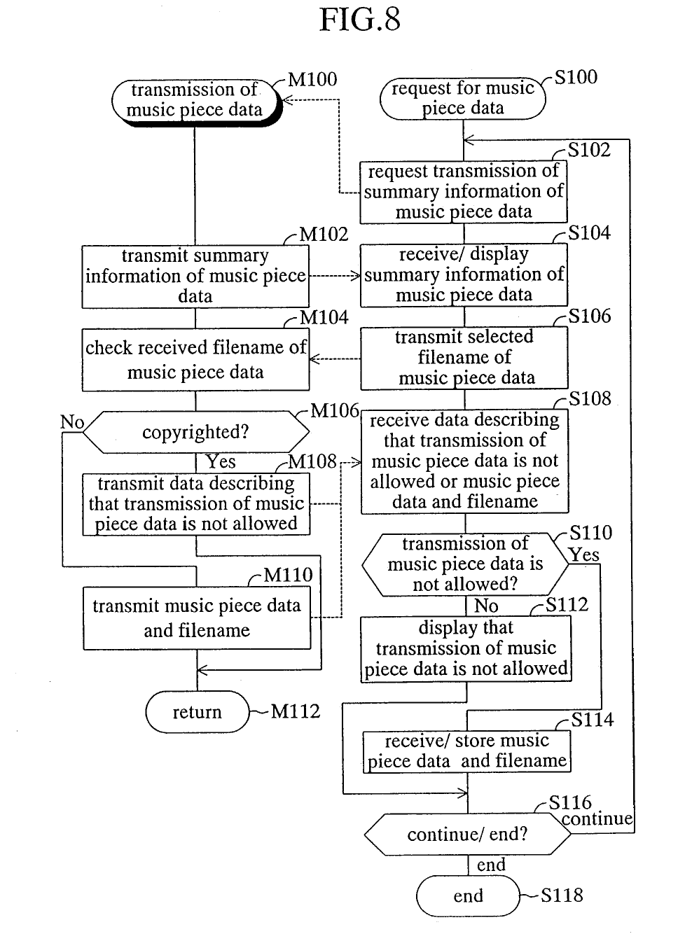

To the bus 20 the interface circuit 51 is also connected. The interface circuit 51 is for inputting various data from an external device 52 such as other electronic musical instrument or personal computer and outputting various data to the external device 52. The external device 52 may be configured as the above-described electronic musical instrument A, but is appropriate as far as the external device 52 has computer capability including at least an operator group, a display unit, a CPU, a timer, a ROM, a RAM, an internal storage device, an external storage device, etc., which are similar to those of the aforementioned electronic musical instrument A. In the present embodiment, particularly, the external device 52 is capable of taking in music piece data from the electronic musical instrument A by executing a music piece data request program shown in FIG. 8 and stored in storage media such as flexible disk FD or compact disk CD. Besides, the interface circuit 51 is allowed to connect to the outside via a communications network 53, enabling the electronic musical instrument A to exchange various programs and data with the outside.

Next, the operations of the embodiment configured as described above will be explained. First, the general operations of the electronic musical instrument A will be described. When the power which is not shown is turned on, the CPU 31 starts executing a main program shown in FIG. 5 at step M10, and executes an initial setting process at step M12. In the initial setting process, the display unit 13, the tone generator 41, the effect circuit 42, the timer 32, the interface circuit 51, etc. are placed in the initial state. On the display unit 13, an initial screen is displayed. The tone generator 41 is set in such a manner as to form tone signals with standard tone color. The effect circuit 42 is set in such a manner as to add standardized effect to tone signals or not to add any effect to tone signals. After the step M12, the loop consisting of processes from step M14 to step M22 is executed.

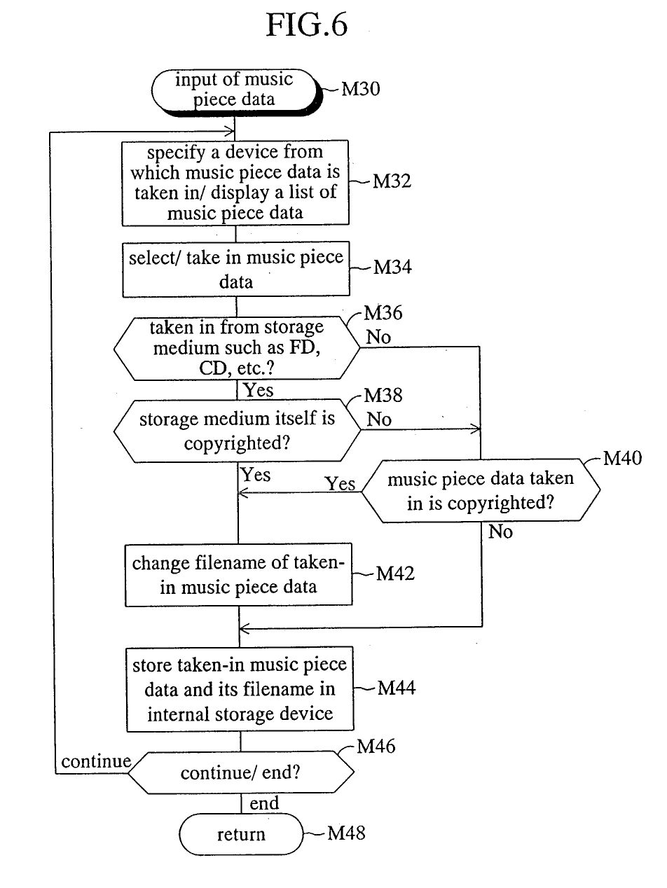

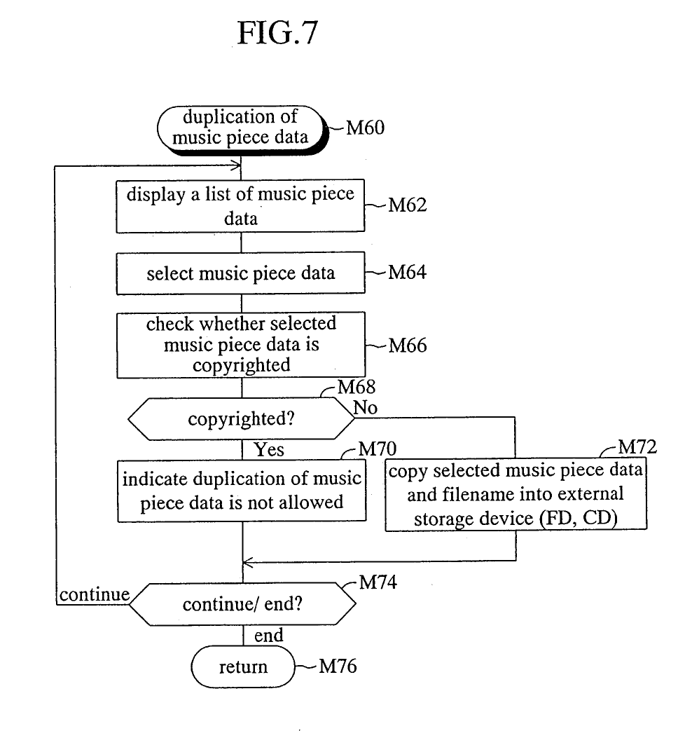

At step M14, operations of the panel operator group 12 are detected. At step M16, in response to the detected operations of the panel operator group 12, a music piece data input/output process is executed. Executed at the music piece data input/output process are a music piece data input routine in FIG. 6, a music piece data duplication routine in FIG. 7, and a music piece data transmission routine in FIG. 8 which will be described in detail later.

At step M18, in response to the detected operations of the panel operator group 12, automatic performance and guidance processes are executed. In the automatic performance process, music piece data representing a music piece selected by a user is replayed. The music piece data referred herein is the data stored in any one device among the ROM 33, the internal storage device 35, and the external storage device 36, or inputted from the external device 52 or the communications network 53 via the interface circuit 51. In order to specify the user's desired music piece data, he/she is required to select his/her desired filename in the entry data on the display unit 13. In order to replay the music piece data, initial setting data is read out and supplied to the tone generator 41 and the effect circuit 42, and MIDI event data is read out at every period a time interval determined by timing data has passed and is supplied to the tone generator 41 or the effect circuit 42 one after another.

The tone generator 41 forms tone signals corresponding to the above-supplied MIDI event data and outputs them to the effect circuit 42. The effect circuit 42 adds to the tone signals effects corresponding to the supplied MIDI event data and outputs the effect-added signals to the sound system 43. The sound system 43 sounds out musical tones corresponding to the effect-added tone signals. It is the process that replays a music piece represented by music piece data.

In the guidance process, performance event data describing note-on and note-off contained in the MIDI event data read out as described above is supplied to the key-depression indicator controlling circuit 15 one after another. In accordance with the performance event data describing note-on and note-off, the key-depression indicator controlling circuit 15 lights up, in good order, the key-depression indicator 11a which corresponds to each key represented by a note number. It is the process that tells a user keys to depress in good order. The guidance process is usually executed in parallel with the automatic performance process routine, that is, while musical tones belonging to one part are sounded out, keys to depress belonging to another part are indicated for the user.

In key-depression/release process at step M20, key-depression/release data (the same as performance event data describing note-on and note-off) which is detected by the detection circuit 14 and describes user's key-depression/release operations of the keyboard 11 is supplied to the tone generator 41. The tone generator 41 forms tone signals corresponding to the above-supplied key-depression/release data, and output the formed signals to the sound system 43. The sound system 43 sounds out musical tones corresponding to the tone signals. It is the process that sounds out musical tones in accordance with performance operations of the keyboard 11.

Executed at step M22, in response to the detection of operations of the panel operator group 12, is the other process for controlling tone color, effect, etc., of musical tones to be generated. In this case, tone color data and effect data in accordance with the operations of the panel operator group 12 is supplied to the tone generator 41, the effect circuit 42, etc. It is the process that changes tone color, effect, etc. of the musical tones to be generated in accordance with the operations of the panel operator group 12.

Next, the music piece data input routine will be described in detail. This routine is for taking in music piece data stored in the external storage device 36 (specifically, flexible disk FD or compact disk CD) to the electronic musical instrument A or for taking in music piece data stored in the external device 52 or various devices connected with the communications network 53 via the interface circuit 51. The music piece data input routine is initiated at step M30 shown in FIG. 6. After the initiation of the music piece data input routine, at step M32 the CPU 31 prompts the user to specify a device where music piece data to be taken in is stored, and displays on the display unit 13 a list of music piece data stored in the specified device.

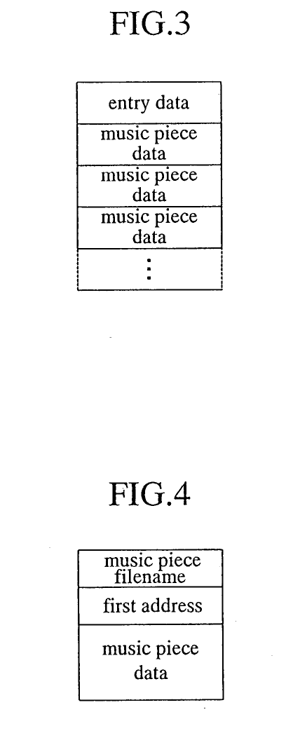

In this case, the CPU 31 first prompts the user to specify a device where music piece data to be taken in is stored (e.g., external storage device 36, external device 52 and various devices connected with the communications network 53, etc.). After the specification of a device, the CPU 31 inputs entry data stored in the specified device, and displays on the display unit 13 the filenames of all sets of music piece data stored in the device. In the device where the music piece data is stored (e.g., external storage device 36, external device 52 and various devices connected with the communications network 53, etc.), entry data and plural sets of music piece data is stored as shown in FIG. 3. The entry data and the music piece data is formatted as shown in FIG. 2.

After processing the step M32, at step M34 the CPU 31 prompts the user to select one or plural filename/filenames from among the filenames displayed on the display unit 13. After the user operates the panel operator group 12 in order to select one or plural filename/filenames, at the step M34 the CPU 31 inputs the music piece data corresponding to the selected filename/filenames from the device in which the music piece data is stored, and temporarily stores it in the RAM 34. The music piece data stored in the RAM 34 is formatted as shown in FIG. 4.

Next at step M36 the CPU 31 determines whether the music piece data is taken in from a storage medium such as flexible disk FD or compact disk CD. This process is required because in the case of music piece data stored in storage media such as flexible disk FD or compact disk CD there is a high possibility that all the music piece data, including the array of the music piece data, is protected by copyright.

When the music piece data is taken in from a storage medium such as flexible disk FD or compact disk CD, the CPU 31 gives “YES” to step M36 and determines at step M38 whether the storage medium itself is copyrighted. At this step, when the storage medium stores copyright information such as composer name, date of composition, producer, or date of production, or has some safeguard for copyright, the CPU 31 determines that the storage medium itself is copyrighted. In other words, the CPU 31 determines that all the music piece data stored in the storage medium is protected by copyright.

When “YES” is given to step M38, that is, when it is determined that the storage medium itself is copyrighted, the CPU 31 proceeds to step M42 in order to change the filename/filenames of the music piece data temporarily stored in the RAM 34 to a predetermined style. In the present embodiment, for example, if the filename data of the music piece data temporarily stored in the RAM 34 is “bluesky.mid”, the filename data “bluesky.mid” is changed to “blueskyxyz.mid”, with a predetermined character string, “xyz” added to the filename part, “bluesky”.

After processing the step M42, the CPU 31 proceeds to step M44 and stores in the internal storage device 35 (flash memory EEPROM, hard disk HD, etc.) the changed filename data and the music piece data temporarily stored in the RAM 34 (see FIG. 2). In this case, along with the changed filename data, the first address data representing the first address of music piece data is stored as entry data in the internal storage device 35.

When the music piece data is not taken in from a storage medium such as flexible disk FD or compact disk CD, the CPU 31 gives “NO” to step M36 and proceeds to step M40. When “NO” is given to step M38, that is, when it is determined that the storage medium itself is not copyrighted, the CPU 31 also proceeds to step M40. At step M40, the CPU 31 determines whether the music piece data which has been taken in is copyrighted. In this case, when copyright information such as composer name, date of composition, producer or date of production is recorded in the music piece data, or when the music piece data is encrypted or has predetermined watermark information, the CPU 31 determines that the music piece data is copyrighted.

When “YES” is given to step M40, that is, when the CPU 31 determines that the music piece data is copyrighted, the CPU 31 proceeds to the step M42 and changes the filename of the music piece data temporarily stored in the RAM 34 to a predetermined style. The CPU 31 then proceeds to the step M44 and stores in the internal storage device 35 (flash memory EEPROM, hard disk HD, etc.) the changed filename and the music piece data temporarily stored in the RAM 34.

On the other hand, when “NO” is given to step M40, that is, when the CPU 31 determines that the music piece data is not copyrighted, the CPU 31 proceeds to step M44 and stores in the internal storage device 35 (flash memory EEPROM, hard disk HD, etc.) the filename data and the music piece data temporarily stored in the RAM 34, skipping the step M42 in which filename data is changed. Therefore, the filename data is not changed. In this case, the first address data representing the first address of music piece data is also stored as entry data in the internal storage device 35.

After processing the step M44, the CPU 31 proceeds to step M46 and determines whether the user has requested to continue taking in another music piece data or to terminate the take-in of music piece data. When neither requests has been made, the CPU 31 waits for a user's request at step M46. When a request to continue taking in another music piece data is made, the CPU 31 returns to step M32 and repeats the steps M32 to M44 in order to take in another music piece data to the internal storage device 35 of the electronic musical instrument A. When a request to terminate the take-in of music piece data is made, on the other hand, the CPU 31 proceeds to step M48 and terminates the music piece data input routine.

The execution of the music piece data input routine enables filename data of copyrighted music piece data to be automatically changed to a predetermined style, eliminating users' operations for protecting copyright such as operations of inputting copyright information.

Next, the music piece data duplication routine will be described in detail. This routine is for copying music piece data stored in the ROM 33 or the internal storage device 35 (specifically, flash memory EEPROM, hard disk HD, etc.) to the external storage device 36 (specifically, flexible disk FD, compact disk CD, etc.). The music piece data duplication routine is initiated at step M60 shown in FIG. 7. After initiating the music piece data duplication routine, at step M62 the CPU 31 displays on the display unit 13 a list of filenames of music piece data stored in the ROM 33 or the internal storage device 35. Next, the CPU 31 proceeds to step M64 and prompts, on the display unit 13, the user to select a file or files (music piece data) from among the listed filenames. In accordance with the user's operations with the panel operator group 12 to select a file/files, the CPU 31 inputs the selected filename/filenames at the step M64.

After processing the step M64, the CPU 31 proceeds to step M66 and checks whether the file (music piece data) selected by the user is copyrighted. Specifically, the CPU 31 checks whether the filename of the selected file has been changed to a predetermined style. Take, for example, “blueskyxyz.mid”, the CPU 31 checks whether the filename includes a predetermined character string, “xyz”. When the file is determined at the step M66 to be copyrighted, the CPU 31 gives “YES” at step M68 and proceeds to step M70. At step M70 the CPU 31 indicates on the display unit 13 that the duplication of the music piece data is not allowed. Then the CPU 31 proceeds to step M74, without copying the music piece data to the external storage device 36.

On the other hand, when the CPU 31 determines at step M66 that the file is not copyrighted, the CPU 31 gives “NO” at step M68 and proceeds to step M72. At step M72 the CPU 31 writes on the external storage device 36 (flexible disk FD, compact disk CD, etc.) the music piece data corresponding to the selected filename along with the filename data, and proceeds to step M74.

At step M74 the CPU 31 determines whether the user has requested to continue duplicating another music piece data or to terminate the duplication of music piece data. When neither request has been made, the CPU 31 waits for a user's request at step M74. When a request to continue duplicating another music piece data is made, the CPU 31 returns to step M62 and repeats the steps M62 to M72 in order to copy another music piece data stored in the ROM 33 or the internal storage device 35 to the external storage device 36. On the other hand, when a request to terminate the duplication of music piece data is made, the CPU 31 proceeds to step M76 and terminates the music piece data duplication routine.

The execution of the music piece data duplication routine protects copyrighted music piece data from being copied to the external storage device 36 (flexible disk FD, compact disk CD, etc.), preventing unauthorized duplication of music piece data and favorably securing copyright on music piece data. The determination whether music piece data is copyrighted can be made easily, for the determination is made simply on the basis of a filename.

Next, the music piece data transmission routine will be described in detail. The routine is for transmitting music piece data stored in the ROM 33, the internal storage device 35 (specifically, flash memory EEPROM, hard disk HD, etc.), or the external storage device 36 (specifically, flexible disk FD, compact disk CD, etc.) in response to a request from the external device 52. The music piece data transmission routine is initiated by executing the music piece data request program in the external device 52.

After the user initiates the music piece data request program in the external device 52 at step S100 shown in FIG. 8, at step S102 the external device 52 requests the electronic musical instrument A to transmit summary information of music piece data stored in the ROM 33, the internal storage device 35 or the external storage device 36 via the interface circuit 51. This request is made by the user's operation on the external device 52 to choose the ROM, the internal device 35, or the external device 36 of the electronic musical instrument A.

This request for transmission of summary information causes the CPU 31 to initiate the music piece data transmission routine in the electronic musical instrument A at step M100. At M102, the CPU 31 transmits the summary information of music piece data stored in the ROM 33, the internal storage device 35 or the external storage device 36, that is, all the filename data in the entry data, to the external device 52. At step S104, the external device 52 receives the above-transmitted filename data, and displays, on the display unit, filenames represented by the received filename data. At the step S104, the external device 52 prompts, on the display unit, the user to select a file or plural files. After the user selects a file/files from among those displayed on the display unit, the external device 52 transmits the selected filename/filenames to the electronic musical instrument A at step S106.

In the electronic musical instrument A, the CPU 31 determines at step M104 whether the music piece data represented by the received filename/filenames is copyrighted. In order to make this determination, the CPU 31 checks whether the received filename/filenames has/have been changed to a predetermined style. Take, for example, “blueskyxyz.mid”, the CPU 31 checks whether the filename includes a predetermined character string, “xyz”. When the music piece data is determined at the step M104 to be copyrighted, the CPU 31 gives “YES” at step M106 and proceeds to step M108. At step M108 the CPU 31 transmits to the external device 52 the data describing that the transmission of the music piece data is not allowed.

On the other hand, when the CPU 31 determines at step M104 that the music piece data is not copyrighted, the CPU 31 gives “NO” at step M106 and proceeds to step M110. At step M110 the CPU 31 reads the music piece data corresponding to the received filename/filenames from the ROM 33, the internal storage device 35 or the external storage device 36 and transmits it along with its filename data to the external device 52. After processing the step M108 and the step M110, the CPU 31 terminates the music piece data transmission routine at step M112.

On the other hand, the data which has been sent at the step M108 and describes that the transmission of the music piece data is not allowed or the music piece data which has been sent along with its filename data at the step M110 is received by the external device 52 at step S108. When the external device 52 receives the data describing that the transmission of the music piece data is not allowed, the external device 52 gives “NO” at step S110 and displays at step S112 on the display unit that the transmission of the music piece data is not allowed. When the external device 52 receives the music piece data along with its filename at the step S108, the external device 52 gives “YES” at step S110 and stores the received music piece data and the filename data in a storage device.

After processing the step S112 or the step S114, the external device 52 determines at step S116 whether a request to continue transmitting music piece data or to terminate transmitting music piece data has been made. When neither request has been made, the external device 52 waits for a user's request at step S116. When a request to continue transmitting music piece data is made, the external device 52 returns to step S102 and executes the processes again from the step S102 to the step S114 in order to continue the program for requesting the electronic musical instrument A to transmit music piece data. When a request to terminates transmission of music piece data is made, on the other hand, the external device 52 terminates the music piece data request program at step S118.

The execution of the music piece data request program and the music piece data transmission routine securely protects copyrighted music piece data from being transmitted from the electronic musical instrument A to the external device 52. As a result, unauthorized duplication of copyrighted music piece data is avoided, with the copyright on music piece data favorably secured. The determination whether music piece data is copyrighted can be made easily, for the determination is made simply on the basis of a filename.

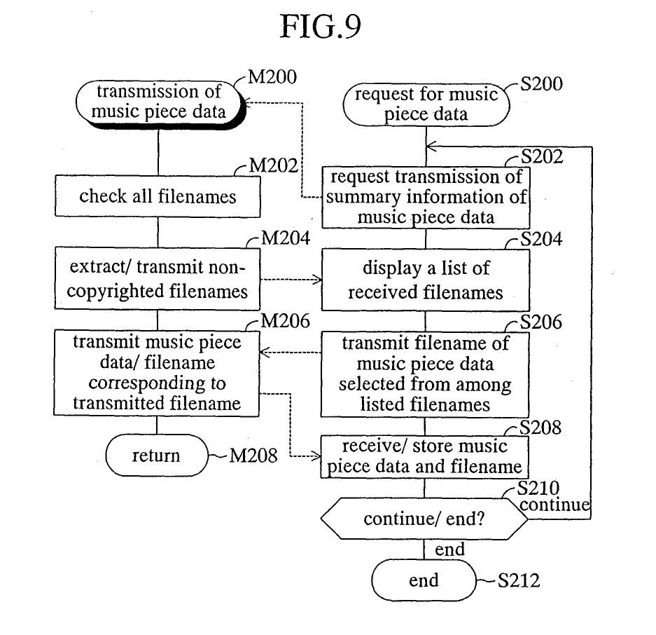

Next explained will be a first modified embodiment in which the music piece data transmission routine and the music piece data request program shown in FIG. 8 are partly modified as shown in FIG. 9. In this case as well, after the user initiates a music piece data request program on the external device 52 at step S200 shown in FIG. 9, as in the case of the above embodiment, the external device 52 requests at step S202 the electronic musical instrument A to transmit summary information of music piece data stored in the ROM 33, the internal storage device 35 or the external storage device 36 via the interface circuit 51.

This request for transmission of summary information causes the CPU 31 to initiate a music piece data transmission routine on the electronic musical instrument A at M200. At step M202 the CPU 31 checks whether the summary information of music piece data, that is, all the filename data included in the entry data stored in the ROM 33, the internal storage device 35 or the external storage device 36 is on copyrighted data. This check is done by determining whether the filenames have been changed to a predetermined style. Take, for example, “blueskyxyz.mid”, the CPU 31 checks whether the filename includes a predetermined character string, “xyz”.

The CPU 31 then extracts filename data on music piece data which is not copyrighted and transmits it to the external device 52. The external device 52 receives the transmitted filename data at step S204 and displays on the display unit the filenames represented by the received filename data. At the step S204 the external device 52 prompts, on the display unit, the user to select a file or plural files from among the displayed filenames. After the user selects a file/files from among those displayed on the display unit, at step S206 the external device 52 transmits the selected filename/filenames to the electronic musical instrument A.

In the electronic musical instrument A, at step M206 the CPU 31 reads the music piece data corresponding to the received filename/filenames from the ROM 33, the internal storage device 35 or the external storage device 36 and transmits it along with its filename to the external device 52. The CPU 31 then terminates the music piece data transmission routine at step M208.

On the other hand, the music piece data transmitted along with its filename at the step M206 is received by the external device 52 at step S208. At the step S208 the external device 52 stores in a storage device the received music piece data along with its filename data. Next, the external device 52 determines at step S210 whether a request to continue transmitting music piece data or to terminate transmitting music piece data has been made. The step S210 is done as in the case of the step S116 of the above-described embodiment. When a request to continue transmitting data is made, the external device 52 returns to the step S202 and executes the processes again from the step S202 to the step S208. When a request to terminate transmitting data is made, on the other hand, the external device 52 terminates the music piece data request program at step S212.

The execution of the music piece data request program and the music piece data transmission routine securely protects the filenames of copyrighted music piece data from being transmitted from the electronic musical instrument A to the external device 52. Therefore, the external device 52 never displays the filenames of copyrighted music piece data, eliminating opportunities of users' selecting copyrighted music piece data and virtually protecting the copyrighted music piece data from being transmitted from the electronic musical instrument A to the external device 52. As a result, unauthorized duplication of copyrighted music piece data is avoided, with the copyright on music piece data favorably secured. The determination whether music piece data is copyrighted can be made easily, for the determination is made simply on the basis of a filename.

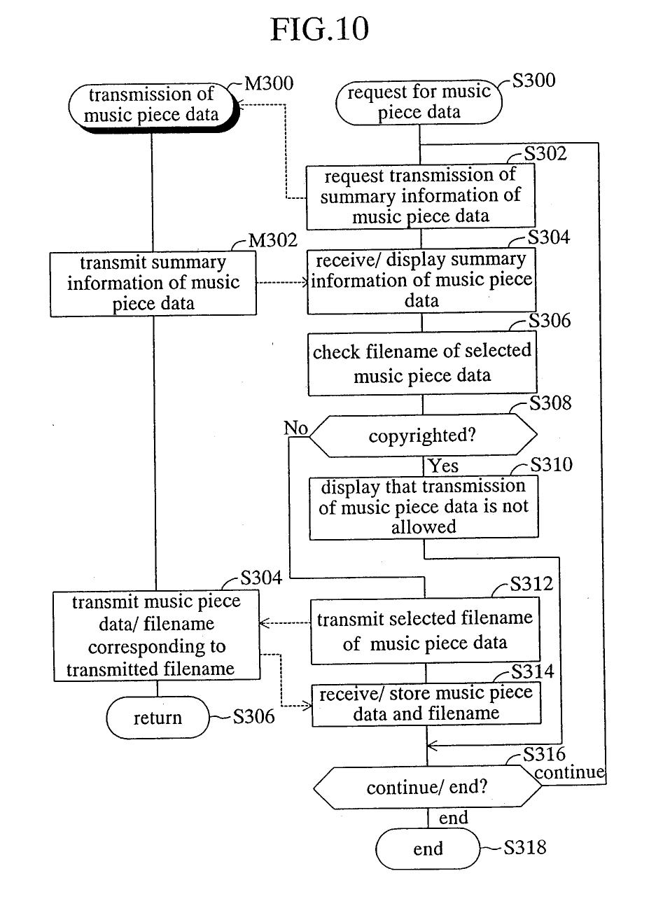

Next explained will be a second modified embodiment in which the music piece data transmission routine and the music piece data request program shown in FIG. 8 are partly modified as shown in FIG. 10. In this case as well, after the user initiates a music piece data request program in the external device 52 at step S300 shown in FIG. 10, as in the case of the above-described embodiment, the external device 52 requests at step S302 the electronic musical instrument A to transmit summary information of music piece data stored in the ROM 33, the internal storage device 35 or the external storage device 36 via the interface circuit 51.

This request for transmission of summary information causes the CPU 31 to initiate a music piece data transmission routine on the electronic musical instrument A at M300. At step M302 the CPU 31 transmits to the external device 52 the summary information of music piece data, that is, all the filename data included in the entry data stored in the ROM 33, the internal storage device 35 or the external storage device 36. At step S304 the external device 52 receives the transmitted filename data and displays on the display unit the filenames represented by the received filename data. At the step S304 the external device 52 also prompts, on the display unit, the user to select a file or plural files from among the displayed filenames.

After the user selects a file/files from among those displayed on the display unit, at step S306 the external device 52 determines whether the music piece data represented by the selected filename/filenames is copyrighted. This determination is done by determining whether the filenames have been changed to a predetermined style. Take, for example, “blueskyxyz.mid”, the external device 52 checks whether the filename includes a predetermined character string, “xyz”. At the step S306 when the music piece data is determined to be copyrighted, the external device 52 gives “YES” at step S308 and proceeds to step S310. At step S310 the external device 52 indicates on the display unit that copy of the music piece data is not allowed.

At the step S306 when it is determined that the music piece data is not copyrighted, on the other hand, the external device 52 gives “NO” at step S308 and proceeds to step S312. At step S312 the external device 52 transmits the selected filename data to the electronic musical instrument A. In the electronic musical instrument A, at step M304 the CPU 31 receives the transmitted filename data, reads the music piece data corresponding to the received filename data from the ROM 33, the internal storage device 35 or the external storage device 36, and transmits it along with its filename to the external device 52. The CPU 31 then terminates the music piece data transmission routine at step M306. At step S314, on the other hand, the external device 52 receives the music piece data transmitted along with its filename from the electronic musical instrument A and stores it in the storage device.

After processing the step S310 or the step S314, the external device 52 determines at step S316 whether a request to continue transmitting music piece data or to terminate transmitting music piece data has been made. The step S316 is done as in the case of the step S116 of the aforementioned embodiment. When a request to continue transmitting data is made, the external device 52 returns to the step S302 and executes the processes again from the step S302 to the step S314. When a request to terminate transmitting data is made, on the other hand, the external device 52 terminates the music piece data request program at step S318.

The execution of the music piece data request program and the music piece data transmission routine securely prevents the external device 52 from requesting the electronic musical instrument A to transmit copyrighted music piece data. As a result, unauthorized duplication of copyrighted music piece data is avoided, with the copyright on music piece data favorably secured. The determination whether music piece data is copyrighted can be made easily, for the determination is made simply on the basis of a filename.

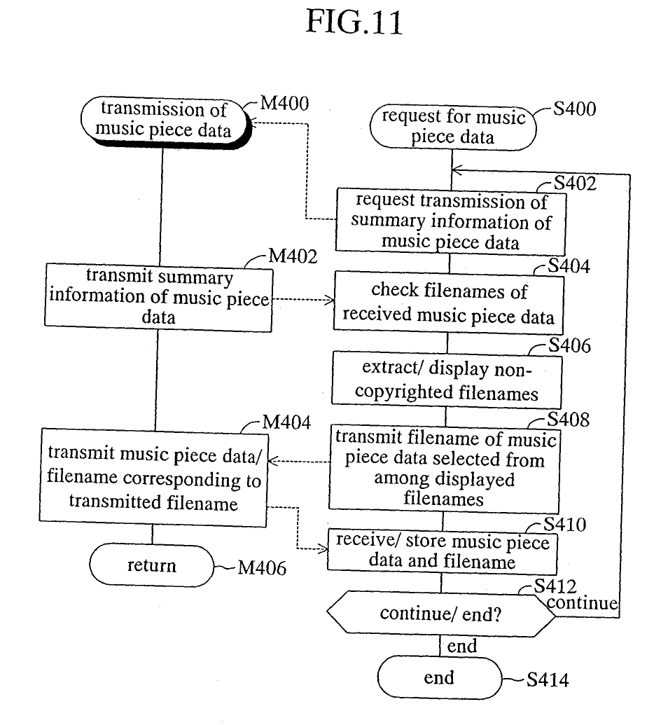

Next explained will be a third modified embodiment in which the music piece data transmission routine and the music piece data request program shown in FIG. 8 are partly modified as shown in FIG. 11. In this case as well, after the user initiates a music piece data request program in the external device 52 at step S400 shown in FIG. 11, as in the case of the above-described embodiment, the external device 52 requests at step S402 the electronic musical instrument A to transmit summary information of music piece data stored in the ROM 33, the internal storage device 35 or the external storage device 36 via the interface circuit 51.

This request for transmission of summary information causes the CPU 31 to initiate a music piece data transmission routine on the electronic musical instrument A at M400. At step M402 the CPU 31 transmits to the external device 52 the summary information of music piece data, that is, all the filename data included in the entry data stored in the ROM 33, the internal storage device 35 or the external storage device 36. At step S404 the external device 52 receives all the transmitted filename data and checks whether the filename data is on copyrighted music piece data. This check is done by determining whether the filenames have been changed to a predetermined style. Take, for example, “blueskyxyz.mid”, the external device 52 checks whether the filename includes a predetermined character string, “xyz”.

At step S406 the external device 52 extracts filename data on music piece data which is not copyrighted and displays on the display unit the filenames represented by the extracted filename data. At the step S406 the external device 52 also prompts, on the display unit, the user to select a file or plural files from among the displayed filenames. After the user selects a file/files from among those displayed on the display unit, at step S408 the external device 52 transmits the selected filename/filenames to the electronic musical instrument A.

In the electronic musical instrument A, at step M404 the CPU 31 receives the filename/filenames transmitted from the external device 52, reads the music piece data corresponding to the received filename/filenames from the ROM 33, the internal storage device 35 or the external storage device 36, and transmits it along with its filename to the external device 52. The CPU 31 then terminates the music piece data transmission routine at step M406.

On the other hand, the music piece data transmitted along with its filename at the step M406 is received by the external device 52 at step S410. At the step S410 the external device 52 stores in a storage device the received music piece data along with its filename data. Next, the external device 52 determines at step S412 whether a request to continue transmitting music piece data or to terminate transmitting music piece data has been made. The step S412 is done as in the case of the step S116 of the above-described embodiment. When a request to continue transmitting data is made, the external device 52 returns to the step S402 and executes the processes again from the step S402 to the step S410. When a request to terminate transmitting data is made, on the other hand, the external device 52 terminates the music piece data request program at step S414.

The execution of the music piece data request program and the music piece data transmission routine securely prevents the external device 52 from displaying the filenames of copyrighted music piece data. Therefore, the external device 52 eliminates an opportunity of users' selecting copyrighted music piece data, virtually prohibiting the copyrighted music piece data from being transmitted from the electronic musical instrument A to the external device 52. As a result, unauthorized duplication of copyrighted music piece data is avoided, with the copyright on music piece data favorably secured. The determination whether music piece data is copyrighted can be made easily, for the determination is made simply on the basis of a filename.

In the above-described embodiments, filename data for copyrighted music piece data is changed by adding a predetermined character string (e.g., “xyz”) to a filename followed by an extension, however, the change may be made by adding a predetermined symbol (e.g., “***”) The change may also be made by changing an extension itself: for example, the original filename data, “bluesky.mid” maybe changed to “blueskyxyz.med”. Furthermore, when the number of characters of filename data is limited (e.g., 8 characters or fewer), part of the filename may be deleted, and a predetermined character string or symbol string may be added: for example, the original filename data, “bluesky.mid” may be changed to “blues***.mid”.

In the above-described embodiments, description has been given on examples in which the electronic musical instrument A having the keyboard 11 as performance operators is used as an electronic musical apparatus of the present invention. As the electronic musical instrument applied to the present invention, however, various musical instruments having touch plates, pushbuttons, strings or the like as performance operators may be used. The present invention is also applicable to various devices capable of generating tone signals such as a sequencer device or a personal computer device.

Furthermore, in carrying out the present invention, it will be understood that the present invention is not limited to the above-described embodiment and its variations, but various modifications may be made without departing from the spirit and scope of the invention.

What is claimed is:

1. An electronic musical apparatus having a storage device capable of storing, on a file-by-file basis, music piece data representative of a music piece along with its filename, a replay portion for reading said music piece data and replaying said music piece, and a take-in portion for taking in desired music piece data from an external storage medium or an external device and storing said music piece data along with its filename in said storage device, said electronic musical apparatus comprising:
a determination portion for determining whether said music piece data taken in by said take-in portion is copyrighted; and
a filename modification portion for changing the filename of said music piece data taken in by said take-in portion to a predetermined style and storing said filename in said storage device when said music piece data is determined by said determination portion to be copyrighted.

2. An electronic musical apparatus having a storage device for storing music piece data representative of a music piece, a replay portion for reading said music piece data stored in said storage device and replaying said music piece, and a writing portion capable of writing said music piece data stored in said storage device into an external storage medium, said electronic musical apparatus comprising:
a determination portion for determining whether said music piece data stored in said storage device is copyrighted; and
a write protection portion for protecting said music piece data determined by said determination portion to be copyrighted from being written by said writing portion into said external storage medium.

3. The electronic musical apparatus according to claim 2, wherein said storage device stores said music piece data on a file-by-file basis, and said determination portion determines whether said music piece data is copyrighted by the filename of said music piece data.

4. An electronic musical apparatus having a storage device for storing music piece data representative of a music piece, a replay portion for reading said music piece data stored in said storage device and replaying said music piece, and an output portion capable of outputting said music piece data stored in said storage device to an external device, said electronic musical apparatus comprising:
a determination portion for determining whether said music piece data stored in said storage device is copyrighted; and
an output protection portion for protecting said music piece data determined by said determination portion to be copyrighted from being outputted by said output portion to said external device.

5. The electronic musical apparatus according to claim 4, wherein said storage device stores said music piece data on a file-by-file basis, and said determination portion determines whether said music piece data is copyrighted by the filename of said music piece data.

6. An electronic musical apparatus having a storage device capable of storing, on a file-by-file basis, music piece data representative of a music piece along with its filename, a replay portion for reading said music piece data stored in said storage device and replaying said music piece, and an output portion capable of outputting said filename stored in said storage device to an external device in response to a request from said external device, and outputting to said external device music piece data corresponding to a filename specified by said external device, said electronic musical apparatus comprising:
a determination portion for determining whether said music piece data stored in said storage device is copyrighted; and
an output protection portion for protecting the filename of music piece data determined by said determination portion to be copyrighted from being outputted by said output portion to said external device.

7. The electronic musical apparatus according to claim 6, wherein said determination portion determines whether said music piece data is copyrighted by the filename of said music piece data.

8. A method applied to an electronic musical apparatus having a storage device capable of storing, on a file-by-file basis, music piece data representative of a music piece along with its filename, said method comprising the steps of:
a replay step for reading said music piece data and replaying said music piece;
a take-in step for taking in desired music piece data from an external storage medium or an external device and storing said music piece data along with its filename in said storage device;
a determination step for determining whether said music piece data taken in by said take-in step is copyrighted; and
a filename modification step for changing the filename of said music piece data taken in by said take-in step to a predetermined style and storing said filename in said storage device when said music piece data is determined by said determination step to be copyrighted.

9. A method applied to an electronic musical apparatus having a storage device for storing music piece data representative of a music piece, said method comprising the steps of:
a replay step for reading said music piece data stored in said storage device and replaying said music piece;
a writing step capable of writing said music piece data stored in said storage device into an external storage medium;
a determination step for determining whether said music piece data stored in said storage device is copyrighted; and
a write protection step for protecting said music piece data determined by said determination step to be copyrighted from being written by said writing step into said external storage medium.

10. The method according to claim 9, wherein said storage device stores said music piece data on a file-by-file basis, and said determination step determines whether said music piece data is copyrighted by the filename of said music piece data.

11. A method applied to an electronic musical apparatus having a storage device for storing music piece data representative of a music piece, said method comprising the steps of:
a replay step for reading said music piece data stored in said storage device and replaying said music piece;
an output step capable of outputting said music piece data stored in said storage device to an external device;
a determination step for determining whether said music piece data stored in said storage device is copyrighted; and
an output protection step for protecting said music piece data determined by said determination step to be copyrighted from being outputted by said output step to said external device.

12. The method according to claim 11, wherein said storage device stores said music piece data on a file-by-file basis, and said determination step determines whether said music piece data is copyrighted by the filename of said music piece data.

13. A method applied to an electronic musical apparatus having a storage device capable of storing, on a file-by-file basis, music piece data representative of a music piece along with its filename, said method comprising the steps of:
a replay step for reading said music piece data stored in said storage device and replaying said music piece;
an output step capable of outputting said filename stored in said storage device to an external device in response to a request from said external device, and outputting to said external device music piece data corresponding to a filename specified by said external device;
a determination step for determining whether said music piece data stored in said storage device is copyrighted; and
an output protection step for protecting the filename of music piece data determined by said determination step to be copyrighted from being outputted by said output step to said external device.

14. The method according to claim 13, wherein said determination step determines whether said music piece data is copyrighted by the filename of said music piece data.

15. A computer program applied to an external device which requests an electronic musical apparatus storing music piece data representative of a music piece to transmit said music piece data, said computer program comprising the steps of:
a determination step for determining whether said music piece data stored in said electronic musical apparatus is copyrighted; and
a prevention step for preventing said external device from requesting said electronic musical apparatus to transmit music piece data determined at said determination step to be copyrighted.

16. A computer program applied to an external device which requests an electronic musical apparatus storing, on a file-by-file basis, music piece data representative of a music piece along with its filename to transmit said music piece data, said computer program comprising the steps of:
a filename transmission request step for requesting transmission of filenames stored in said electronic musical apparatus;
a display step for displaying, on a display unit, filenames transmitted from said electronic musical apparatus in response to said request for filename transmission;
a determination step for determining whether a filename selected by a user from among said filenames displayed on said display unit is of copyrighted music piece data; and
a music piece data transmission request step for requesting said electronic musical apparatus to transmit music piece data corresponding to a filename determined at said determination step not to be copyrighted.

17. A computer program applied to an external device which requests an electronic musical apparatus storing, on a file-by-file basis, music piece data representative of a music piece along with its filename to transmit said music piece data, said computer program comprising the steps of:
a filename transmission request step for requesting transmission of filenames stored in said electronic musical apparatus;
a determination step for determining whether filenames transmitted from said electronic musical apparatus in response to said request for filename transmission are of copyrighted music piece data;
a display step for displaying, on a display unit, filenames determined at said determination step not to be copyrighted among those filenames transmitted from said electronic musical apparatus; and
a music piece data transmission request step for requesting said electronic musical apparatus to transmit music piece data corresponding to a filename selected by a user from among said filenames displayed on said display unit at said display step.
